(19) United States
(12) Patent Application Publication
(10) Pub. No.: US 2023/0262144 A1
(43) Pub. Date: Aug. 17, 2023

(54) Collaboration Method and Intelligent Device Group

(71) Applicant: Huawei Technologies Co., Ltd., Shenzhen (CN)

(72) Inventors: Yan Zeng, Shenzhen (CN); Zongfang Lin, Shenzhen (CN)

(21) Appl. No.: 18/304,699

(22) Filed: Apr. 21, 2023

Related U.S. Application Data
(63) Continuation of application No. 17/244,523, filed on Apr. 29, 2021.
Application No. 17/244,523 is a continuation of application No. PCT/CN2019/097080, filed on Jul. 22, 2019.

(30) Foreign Application Priority Data
Oct. 31, 2018 (CN) 201811288920.2

(51) Int. Cl. H04L 67/63; G06F 9/50; H04L 12/18

(52) U.S. Cl. CPC H04L 67/63; G06F 9/5072; H04L 12/1827

(57) ABSTRACT

A collaboration method includes receiving, by a first intelligent device, a task instruction, determining, according to the task instruction and based on device data of the first intelligent device, and device data of at least one second intelligent device in an intelligent device subgroup in which the first intelligent device is located, a subtask corresponding to the first intelligent device by using a collaboration algorithm, where the collaboration algorithm is consistent with a collaboration algorithm that is in the second intelligent device and that is used to determine a subtask corresponding to the second intelligent device, and the subtask corresponding to the first intelligent device is used to collaborate with the subtask corresponding to the second intelligent device to complete a task corresponding to the task instruction, and executing, the subtask corresponding to the first intelligent device.

### CROSS-REFERENCE TO RELATED APPLICATIONS

This is a continuation of U.S. patent application Ser. No. 17/244,523 filed on Apr. 29, 2021, which is a continuation of International Patent Application No. PCT/CN2019/097080 filed on Jul. 22, 2019, which claims priority to Chinese Patent Application No. 201811288920.2 filed on Oct. 31, 2018. All of the aforementioned patent applications are hereby incorporated by reference in their entireties.

### TECHNICAL FIELD

The present disclosure relates to the artificial intelligence field and the distributed field, and in particular, to a collaboration method for an intelligent device group.

### BACKGROUND

In present daily life, technologies such as an artificial intelligence technology and a distributed technology develop rapidly, and intelligent devices are proliferating. Common intelligent devices include intelligent acoustic equipment, an intelligent rice cooker, and an intelligent light bulb. Nowadays, smart households are gradually entering people's life. In most cases, the intelligent devices can independently complete a task. For example, intelligent acoustic equipment plays music, or an intelligent robot does the cleaning independently.

With popularization of the intelligent devices, increasingly high requirements are imposed on the intelligent devices, and a single device cannot meet optimal user experience. A conventional method, such as a multi-channel method, is expensive to implement. In addition, existing intelligent devices are currently incapable of group collaboration to complete a complex task, which may cause chaos during implementation.

### SUMMARY

Embodiments of the present disclosure provide a collaboration method for an intelligent device group. A device group is established by devices for collaboration, so that knowledge of the devices is integrated, and decision-making and task division are performed based on a task, to implement collaboration. This may complete a complex task, improve work efficiency, and provide optimal experience.

According to a first aspect, a collaboration method is provided. The method includes receiving, by a first intelligent device, a task instruction, determining, according to the task instruction and based on device data of the first intelligent device, and device data of at least one second intelligent device in an intelligent device subgroup in which the first intelligent device is located, a subtask corresponding to the first intelligent device by using a collaboration algorithm, where the collaboration algorithm is consistent with a collaboration algorithm that is in the second intelligent device and that is used to determine a subtask corresponding to the second intelligent device, and the subtask corresponding to the first intelligent device is used to collaborate with the subtask corresponding to the second intelligent device to complete a task corresponding to the task instruction, and executing the subtask corresponding to the first intelligent device.

In a possible implementation, the method further includes sending, by the first intelligent device, the task instruction to the at least one second intelligent device in the intelligent device subgroup in which the first intelligent device is located.

In a possible implementation, the receiving, by the first intelligent device, a task instruction includes receiving, by the first intelligent device, a task instruction sent by a third intelligent device, where the third intelligent device is any intelligent device, in an intelligent device group, other than the first intelligent device and the at least one second intelligent device. The intelligent device group includes the intelligent device subgroup in which the first intelligent device is located.

In a possible implementation, the intelligent device group is established by a plurality of intelligent devices by using a network, and the plurality of intelligent devices include the first intelligent device, the at least one second intelligent device, and the third intelligent device.

In a possible implementation, the intelligent device group includes at least one intelligent device subgroup. Device data of the plurality of intelligent devices includes device function information, the at least one intelligent device subgroup is obtained after classification of the plurality of intelligent devices based on the device function information, and the at least one intelligent device subgroup includes the intelligent device subgroup in which the first intelligent device is located.

In a possible implementation, manners in which the first intelligent device obtains the device data of the at least one second intelligent device includes multicast, broadcast, or gossip.

According to a second aspect, an intelligent device group is provided, including a plurality of intelligent devices. The plurality of intelligent devices include a first intelligent device and at least one second intelligent device. The first intelligent device receives a task instruction, according to the task instruction and based on device data of the first intelligent device, and device data of the at least one second intelligent device in an intelligent device subgroup in which the first intelligent device is located, a subtask corresponding to the first intelligent device is determined by using a collaboration algorithm, where the collaboration algorithm is consistent with a collaboration algorithm that is in the second intelligent device and that is used to determine a subtask corresponding to the second intelligent device, and the subtask corresponding to the first intelligent device is used to collaborate with the subtask corresponding to the second intelligent device to complete a task corresponding to the task instruction, and the subtask corresponding to the first intelligent device is executed.

In a possible implementation, the intelligent device group further includes the first intelligent device, configured to send the task instruction to the at least one second intelligent device in the intelligent device subgroup in which the first intelligent device is located.

In a possible implementation, that the first intelligent device receives a task instruction includes receiving, by the first intelligent device, a task instruction sent by a third intelligent device, where the third intelligent device is any intelligent device, in the intelligent device group, other than the first intelligent device and the at least one second intelligent device. The intelligent device group includes the intelligent device subgroup in which the first intelligent device is located.

In a possible implementation, the intelligent device group is established by the plurality of intelligent devices by using a network, and the plurality of intelligent devices include the first intelligent device, the at least one second intelligent device, and the third intelligent device.

In a possible implementation, the intelligent device group includes at least one intelligent device subgroup. Device data of the plurality of intelligent devices includes device function information. The at least one intelligent device subgroup is obtained after classification of the plurality of intelligent devices based on the device function information, and the at least one intelligent device subgroup includes the intelligent device subgroup in which the first intelligent device is located.

In a possible implementation, manners in which the first intelligent device obtains the device data of the at least one second intelligent device include multicast, broadcast, or gossip.

According to a third aspect, a computer-readable storage medium storing a program is provided, where the program includes instructions, and when the instructions are executed by a terminal, the terminal performs the method according to the first aspect.

According to a fourth aspect, a computer program product including instructions is provided. When the computer program product runs on a computer, the computer performs the method according to the first aspect.

The present disclosure discloses a collaboration method for an intelligent device group and a device group, so that in an area, intelligent devices may sense and discover each other independently, and establish an intelligent device subgroup. In addition, a plurality of intelligent devices in the intelligent device subgroup collaborate with each other, to construct subgroup group information, so as to ensure that each intelligent device in the intelligent device subgroup has same initial information when executing a task. Finally, the intelligent devices collaboratively make a decision and complete a complex task. This resolves a problem that a single device is not fully capable of independently completing a task, and reduces information interaction between the intelligent device and a central device by removing a central node of the group of devices. In addition, a task processing solution may be dynamically adjusted based on calculation, to provide optimal user experience.

### BRIEF DESCRIPTION OF DRAWINGS

FIG. 1 is a flowchart of a collaboration method according to an embodiment of the present disclosure.

FIG. 2 is a schematic diagram of an application scenario according to an embodiment of the present disclosure.

FIG. 3A is a schematic diagram of an application scenario in which a cloud platform is used as a center in other approaches.

FIG. 3B is a schematic diagram of an application scenario in which a central control platform is used as a center in other approaches.

FIG. 4 is a schematic diagram of an application scenario in which intelligent devices are sequentially triggered in other approaches.

FIG. 5 is a schematic diagram of another application scenario according to an embodiment of the present disclosure.

FIG. 6 is a schematic diagram of an intelligent device group according to an embodiment of the present disclosure.

### DESCRIPTION OF EMBODIMENTS

The following describes the technical solutions in embodiments of the present disclosure with reference to the accompanying drawings in the embodiments of the present disclosure.

The present disclosure provides a collaboration method. The method independently senses and discovers a plurality of intelligent devices in an area, and establishes an intelligent device subgroup. After receiving a task instruction, the plurality of intelligent devices in the intelligent device subgroup collaborate with each other. The plurality of intelligent devices in the intelligent device subgroup share device data of each device, and the plurality of intelligent devices collaborate with each other to complete a complex task, thereby providing optimal experience for a user.

It should be understood that “first”, “second”, and “third” in “first intelligent device”, “second intelligent device”, and “third intelligent device” mentioned below do not indicate an order, but are merely a given label to distinguish an intelligent device that receives a task and an intelligent device that executes a task, for clarity of description.

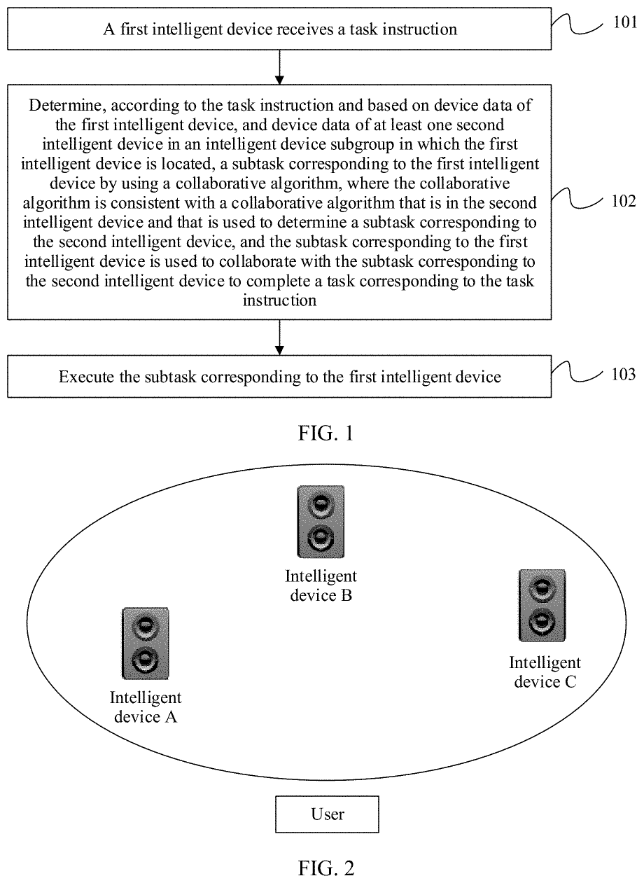

FIG. 1 is a flowchart of a collaboration method according to an embodiment of the present disclosure.

As shown in FIG. 1, this embodiment of the present disclosure provides a collaboration method, and the method includes the following steps.

Step 101. A first intelligent device receives a task instruction, where the task instruction may include a task type.

In this embodiment of the present disclosure, intelligent devices in a same network form an intelligent device group, for example, a plurality of intelligent devices in a same local area network form one intelligent device group by using WI-FI, BLUETOOTH, ZIGBEE, or the like. The plurality of intelligent devices may communicate with each other by using a network.

Any device in the intelligent device group may receive a task instruction delivered by a user. The received task instruction may be a complex task instruction, for example, scanning an entire building or playing a symphony played by various instruments. In this embodiment of the present disclosure, any intelligent device that receives the task instruction in the intelligent device group may be referred to as the first intelligent device. For example, the intelligent device group includes intelligent devices such as a smart television, a smart kettle, a sweeping robot A, and a sweeping robot B, and any one of the intelligent devices may receive the task instruction delivered by the user.

Step 102. Determine, according to the task instruction and based on device data of the first intelligent device, and device data of at least one second intelligent device in an intelligent device subgroup in which the first intelligent device is located, a subtask corresponding to the first intelligent device by using a collaboration algorithm, where the collaboration algorithm is consistent with a collaboration algorithm that is in the second intelligent device and that is used to determine a subtask corresponding to the second intelligent device, and the subtask corresponding to the first intelligent device is used to collaborate with the subtask corresponding to the second intelligent device to complete a task corresponding to the task instruction.

In an embodiment, that a first intelligent device receives a task instruction includes receiving, by the first intelligent device, a task instruction sent by a third intelligent device, where the third intelligent device is any intelligent device, in the intelligent device group, other than the first intelligent device and the at least one second intelligent device. The intelligent device group includes the intelligent device subgroup in which the first intelligent device is located.

In an example, an intelligent device that first receives a task may not be an intelligent device in an intelligent device subgroup that needs to execute the task. For example, the smart television receives a sweeping task, but the smart television cannot complete the received task. Therefore, the task needs to be sent to any one of sweeping robots in a sweeping subgroup that can complete the sweeping task.

In an embodiment, the intelligent device group is established by the plurality of intelligent devices by using a network, and the plurality of intelligent devices include the first intelligent device, the at least one second intelligent device, and the third intelligent device.

In an embodiment, the intelligent device group includes at least one intelligent device subgroup. Device data of the plurality of intelligent devices includes device function information, the at least one intelligent device subgroup is obtained after classification of the plurality of intelligent devices based on the device function information, and the at least one intelligent device subgroup includes the intelligent device subgroup in which the first intelligent device is located.

The intelligent device subgroup is an intelligent device group established after negotiation by the plurality of intelligent devices having a same device function in the intelligent device group. A process may be as follows.

For example, in an area, a plurality of intelligent devices establish a connection to another device by using WI-FI, BLUETOOTH, or ZIGBEE, to form an intelligent device group. The group includes all intelligent devices in the foregoing area. In this case, each intelligent device may sense an ambient environment by using one or more sensors of the intelligent device, and information about a distance, a direction, a location, and the like between the intelligent device and another intelligent device. In addition, the plurality of intelligent devices send respective device data to each other. The device data may include information such as device function information. In the intelligent device group, the plurality of intelligent devices are classified into a plurality of intelligent device subgroups based on received device data. In an example, the intelligent devices may be classified based on the device function information. For example, intelligent devices with a playing function are classified into one category, such as an acoustic equipment, a mobile phone, and a television, intelligent devices with a cooking function are classified into one category, such as an intelligent rice cooker, a microwave oven, and an intelligent kettle, intelligent devices with a cleaning function are classified into one category, such as a cleaning robot and an intelligent cooker hood, and intelligent devices with an image shooting function are classified into one category, such as the mobile phone and a camera. A person skilled in the art should note that the foregoing classification manner is merely a possible implementation. In addition, because one intelligent device, for example, a mobile phone, has a plurality of different functions, the intelligent device may be classified into different types of intelligent device subgroups at the same time.

Optionally, in an embodiment, each intelligent device in the intelligent device group sends the device data to each other, and the device data includes the device function information. The intelligent device group is divided into at least one intelligent device subgroup based on the device function information, and each intelligent device subgroup includes at least two intelligent devices. There may be one intelligent device subgroup, and the subgroup includes a plurality of intelligent devices. Alternatively, there may be a plurality of intelligent device subgroups, and each subgroup includes at least two intelligent devices.

After the intelligent device subgroup is obtained after classification, each intelligent device includes information of each intelligent device in a same intelligent device group, for example, an intelligent device subgroup to which the intelligent device belongs. When any intelligent device in the intelligent device group receives the task instruction, according to a task type in the task instruction, an intelligent device subgroup that may execute the task is determined, and then the task is sent to any intelligent device in the intelligent device subgroup that may execute the task.

In a possible embodiment, a third intelligent device receiving a complex task selects, based on a task type, an intelligent device subgroup suitable for executing the foregoing task instruction from a plurality of intelligent device subgroups having different functions. When the received task instruction needs to be completed by an intelligent device subgroup, the third intelligent device receiving the task sends the task instruction to any intelligent device in the intelligent device subgroup that is ready to execute the task instruction. An intelligent device that receives the task instruction in the intelligent device subgroup that is ready to execute the task instruction is the first intelligent device. For example, the smart television in an intelligent device group receives a task instruction that is delivered by the user and that is to clean a floor, and the task instruction includes a task type sweeping. In this case, the smart television determines an intelligent device subgroup that performs sweeping, for example, an intelligent sweeping robot subgroup including a sweeping robot A and a sweeping robot B. Then, the smart television sends the sweeping task to the sweeping robot A or the sweeping robot B in the intelligent sweeping robot subgroup.

In an embodiment, the first intelligent device sends the task instruction to the at least one second intelligent device in the intelligent device subgroup in which the first intelligent device is located.

In another embodiment, the first intelligent device and the second intelligent device may be a same intelligent device. When the first intelligent device and the second intelligent device are a same intelligent device, to improve efficiency, a task may be directly executed, and a step of “sending a task instruction to any second intelligent device in an intelligent device subgroup” is omitted.

In an embodiment, in the step 102, according to the task instruction and based on the device data of the first intelligent device, and the device data of the at least one second intelligent device in the intelligent device subgroup in which the first intelligent device is located, the subtask corresponding to the first intelligent device is determined by using the collaboration algorithm. In an intelligent device subgroup that executes the task, any intelligent device is the first intelligent device, and other intelligent devices in the same intelligent device subgroup except the intelligent device are second intelligent devices. Therefore, to ensure consistency of information about a plurality of intelligent devices in a same intelligent device subgroup, subgroup group information may be generated through negotiation based on the device data of the first intelligent device and the device data of the at least one second intelligent device in the intelligent device subgroup in which the first intelligent device is located. The subgroup group information may be generated in the following manners.

For example, optionally, in an embodiment, intelligent devices in each intelligent device subgroup is converged based on device data to obtain converged data, and the intelligent devices in each intelligent device subgroup generates subgroup group information through negotiation based on the converged data.

The device data includes sensor data. That the intelligent devices in each intelligent device subgroup is converged based on device data to obtain conversion data includes the intelligent devices in each intelligent device subgroup generates one or more pieces of the converge data based on one or more pieces of sensor data measured by the intelligent device, or the intelligent devices in each intelligent device subgroup generates one or more pieces of the converged data based on one or more pieces of sensor information measured by the intelligent device and received sensor data of another intelligent device in the same intelligent device subgroup.

In an example, the intelligent devices in the intelligent device subgroup send device data to each other, and sending manners includes multicast, broadcast, gossip, or the like. The gossip may be periodic gossip, and the like. A gossip method is an eventual consistency algorithm and has a feature of decentralization. In a cluster, each node periodically and randomly selects a specific quantity of nodes to transmit information of the node, and finally, all nodes in the cluster reach an agreement on information. In a possible example, the foregoing node may be an intelligent device in the present disclosure.

In a possible example, a sensor knowledge convergence algorithm is provided in which characteristic sensor conversion data is generated based on sensor data of the intelligent device.

$${D}_{i} = {f}_{1} ( {S}_{i 1} , {S}_{i 2} , {S}_{i 3} , … , {S}_{i m} ) , i = [ 1 , n ] , that is$$

$${D}_{i} = \frac{1}{m} {\sum }_{j = 1}^{m} k {S}_{ij} , i = [ 1 , n ]$$

where Dᵢ is sensor conversion data of an i^{th} intelligent device, Sᵢⱼ is a j^{th} piece of sensor data of the i^{th} intelligent device, k is a weight of a j^{th} sensor, m is a quantity of sensors of the i^{th} intelligent device, and n is a quantity of intelligent devices. In the foregoing formula, an average value of a plurality of pieces of sensor data of the i^{th} intelligent device is obtained, that is, all detected sensor data of the device is first accumulated, and then an average value is obtained, to obtain current characteristic sensor conversion data of the i^{th} intelligent device.

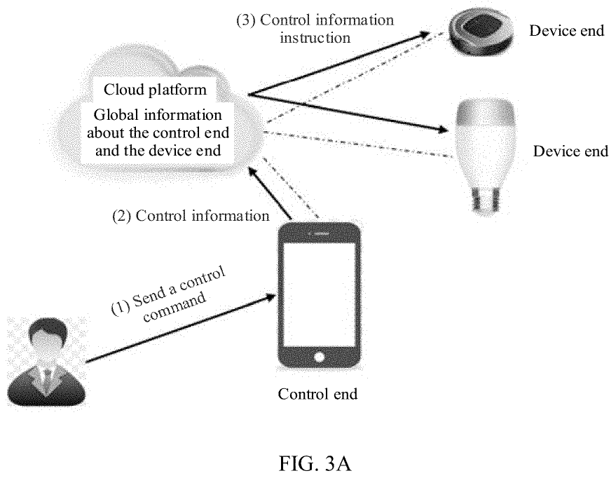

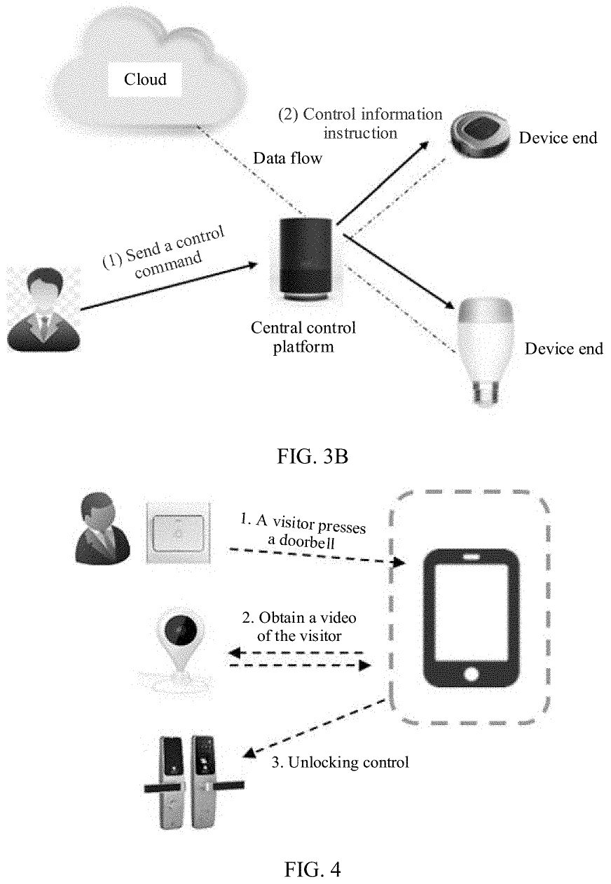

In an example, as shown in FIG. 3, for example, the user needs a plurality of intelligent acoustic equipment to play music, such as intelligent acoustic equipment A, intelligent acoustic equipment B, and intelligent acoustic equipment C. The intelligent acoustic equipment A may detect a distance between the intelligent acoustic equipment A and the user by using a sensor of the intelligent acoustic equipment A. However, to ensure more accurate detection, a plurality of sensors of the intelligent acoustic equipment A may be used to detect a location of the user at the same time, and then an average value of detected sensor data is obtained. Because different sensors have different precision, in another example, different weights may be further set for different sensors. For example, if accuracy of a sensor 1 is higher, a weight of the sensor 1 may be set to 0.6, a weight of a sensor 2 may be set to 0.3, and a weight of a sensor 3 may be set to 0.1.

It may be understood that, further, to obtain location information of the user more accurately, the intelligent acoustic equipment A may further obtain sensor data of another intelligent device, to perform multi-device multi-sensor data convergence.

$${W}_{i , x} = {f}_{2} ( {D}_{1} , {D}_{2} , {D}_{3} , … , {D}_{n} ) , x = [ 1 , + ∞ ] , that is$$

$${W}_{i , x} = \frac{1}{n} {\sum }_{i = 1}^{n} h {D}_{i} , i = [ 1 , n ]$$

where W_{i,x} is an x^{th} piece of feature data of the i^{th} intelligent device, and h is a weight of the i^{th} intelligent device. In an example, W_{1,1} may be a location feature of a first intelligent device, W_{1,2} may be a temperature feature of the first intelligent device, W_{2,1} may be a location feature of a second intelligent device, and the like. In the foregoing formula, an average value of feature sensor data of the plurality of intelligent devices is obtained, that is, feature sensor conversion data of the plurality of intelligent devices is first accumulated, and then an average value is obtained, to obtain feature data of an x^{th} feature.

In an example, sensor data of the intelligent acoustic equipment B and the intelligent acoustic equipment C is actively transmitted to the intelligent acoustic equipment A, for example, in a manner of multicast, broadcast, or gossip. The intelligent acoustic equipment A obtains the sensor data of the intelligent acoustic equipment B and the intelligent acoustic equipment C at the same time, and obtains, by performing a calculation method in which different weights are accumulated and an average value is obtained, location information D₂ of the user detected by the intelligent acoustic equipment B and location information D₃ of the user detected by the intelligent acoustic equipment C. Then, the intelligent acoustic equipment A comprehensively performs analysis and determining based on location information of the intelligent acoustic equipment B, D₂ with a weight, location information of the intelligent acoustic equipment C, D₃ with a weight, and location information of the user detected by the intelligent acoustic equipment A, to finally obtain more accurate location information W₁ of the user. In a possibility, if an intelligent acoustic equipment B is far away from the user and has a relatively small weight, during obtaining of feature data, impact of data detected by the intelligent acoustic equipment B on a finally obtained calculation result is weakened.

A person skilled in the art should note that, that the characteristic sensor conversion data and the characteristic data are obtained by calculating through average is only a possible implementation, and the characteristic sensor conversion data and the characteristic data may also be obtained by a calculation method in another manner. This is not specifically limited in the present disclosure herein.

In an embodiment, all intelligent devices comprehensively analyze and make a decision based on obtained conversion data and device data of all the intelligent devices, and generate subgroup group information. The device data further includes device performance and location information. For example, in the scenario in FIG. 2, the user location information detected by the intelligent acoustic equipment A, and location information and device performance of the intelligent acoustic equipment A. The device performance is, for example, that an intelligent device A is suitable for playing piano music, the intelligent device B may be suitable for playing violin music, and an intelligent device C is suitable for playing flute music. Finally, when a piece of music needs to be played, based on the subgroup group information, the intelligent device A may play a piano part and properly adjust volume, the intelligent device B may play a violin part and properly adjust the volume, and the intelligent device C may play a flute part and properly adjust the volume. In this way, the user can hear the music with a best effect.

In an embodiment, after the task is executed, the method further includes each intelligent device records a historical optimal value of each intelligent device and a group optimal value. In the scenario shown in FIG. 2, each time after music is played, the user may tell, based on an actual effect, the intelligent device how a current playback effect is. As a quantity of task execution times increases, the user may think that currently the intelligent device B plays particularly well, and next time, the user may think that the intelligent device A plays relatively well. The intelligent device may record the historical optimal value of each intelligent device and the group optimal value. In this way, as a quantity of tasks increases, the intelligent device may perform iterative update on feature data of the intelligent device, to provide optimal experience for the user.

In an example, that the intelligent device performs iterative update on feature data of the intelligent device may be

V′_{i,x}=V_{i,x}+c₁r₁(P_{i best}−Wₓ)+c₂r₂(G_{best}−Wₓ)

W′_{i,x}=W_{i,x}+V_{i,x}

where V_{i,x} is a feature change vector of the x^{th} feature of the i^{th} intelligent device, V′_{i,x} is the feature change vector of the updated x^{th} feature of the i^{th} intelligent device, W′_{i,x} is the updated x^{th} feature data of the i^{th} intelligent device, P_{i best} is a historical optimal value of the i^{th} intelligent device, G_{best} is a historical optimal value of the intelligent device subgroup, c₁ and c₂ are learning factors, and r₁ and r₂ are random probability values between 0 and 1. P_{i best} and G_{best} are iteratively updated and adjusted with a target function. The target function may be user satisfaction, task completion, and the like.

A person skilled in the art should note that the foregoing calculation method used by the intelligent device to perform iterative update on the characteristic data of the intelligent device is merely a possible implementation, and may also be obtained by calculation in any other manner. This is not specifically limited in the present disclosure.

For another example, in another embodiment, the device data may further include a task score, location information, coverage range information, and the like. The subgroup group information is generated through negotiation by the intelligent devices in each intelligent device subgroup based on task scores, positioning information, and coverage range information of the intelligent devices. In this embodiment of the present disclosure, the subgroup group information may also be a topological diagram.

The task score is obtained through calculation of feature information and a task type of the intelligent device that are obtained by the intelligent devices in each intelligent device subgroup. The task type may be a task type of a history task. In an example, for a song, assuming that the song is a piano song, a score calculated by the intelligent device A that is good at playing piano music may be relatively high, and a score calculated by the intelligent device B that is good at playing violin music may be relatively low. Then, a task type that each intelligent device excels in is obtained based on the task score. Each intelligent device in the intelligent device subgroup sends the device data to each other. The device data further includes the task score, the location information, the coverage range information, and the like. The task score is a task score calculated by the intelligent device based on the feature information and the task type. Finally, the subgroup group information is generated. In the subgroup information, the intelligent devices are used as points, and lines between the intelligent devices are used as edges. Attributes of the edges include location information, a distance, and a coverage range between the intelligent devices. Properties of the points include a function and performance of the intelligent device and a task type that the intelligent device is good at. There may be a plurality of task types that the intelligent device is good at, and several task types that the intelligent device is best at are obtained based on the task score.

Optionally, in an embodiment, the subgroup group information may be a topological diagram. In the topological diagram, the intelligent devices are used as the points, and the lines between the intelligent devices are used as edges. The attributes of the edges include information such as the location information, the distance, and the coverage range between the intelligent devices. The attributes of the points include the function, performance, and the task type of the intelligent device.

A person skilled in the art should note that, in the foregoing topological diagram, attributes of the points and the edges may be arbitrarily deleted as required, and the protection scope of the present disclosure is not limited thereto.

Step 103. Execute the subtask corresponding to the first intelligent device.

In some existing solutions, a series of events are completed by association of a center, for example, a router or a cloud platform, and are uniformly coordinated and completed by the center. In a solution in which unified collaboration is performed by using the cloud platform as the center, as shown in FIG. 3A, all device ends and control ends need to establish connections to the cloud platform, and the cloud platform has global information of the control ends and the device ends. When the user sends a command to the control end, the control end sends related control information to the cloud platform after receiving the command of the user. Then, the cloud platform performs scheduling and collaboration based on the received global information of the control end, and sends the control information to a related device end. Alternatively, in a solution in which unified collaboration is performed by using a control device as the center, as shown in FIG. 3B, all device ends establish connections to a central control platform, and the central control platform further establishes a connection to the cloud platform for data transmission. The user sends a control command to the central control platform. After receiving the command of the user, the central control platform sends a control instruction to a related device based on the command of the user and information about the device ends connected to the platform.

In some other existing solutions, intelligent devices are sequentially triggered. As shown in FIG. 4, after a user presses a doorbell, the doorbell sends information to a mobile phone, the mobile phone sends a video obtaining command to an intelligent camera, and the intelligent camera returns information of the video to the mobile phone. The mobile phone finally sends an unlocking command to a smart lock, to complete an unlocking task.

Compared with existing solutions, the present disclosure uses a plurality of intelligent devices to automatically establish intelligent device group and share knowledge to form a knowledge topology, so that each intelligent device in the group has same information. A necessary central node is not required. In the existing solution, when a problem occurs on a cloud platform, a central control platform, or a sequential trigger, a system breaks down and cannot run. However, in the present disclosure, each intelligent device has global information at the same time, and each device can perform calculation and task allocation, and can perfectly process a complex task.

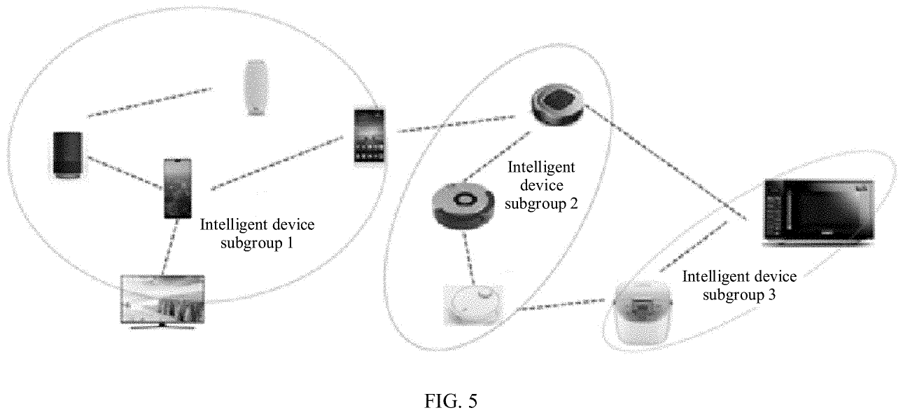

The following describes the technical solutions of the present disclosure by using a specific example, as shown in FIG. 5.

FIG. 5 is a schematic diagram of another application scenario according to an embodiment of the present disclosure.

As shown in FIG. 5, in a household or an office area, a plurality of intelligent devices form an intelligent device group by using Wi-Fi, Bluetooth, and the like. Information such as a function and a device type of the device is synchronized between the plurality of intelligent devices. Based on a device function, “homogeneous” intelligent devices are automatically classified into a plurality of intelligent device subgroups. For example, a mobile phone, a television, and acoustic equipment with a playing function are classified into an intelligent device subgroup 1. Intelligent devices with a cleaning function, such as a sweeping robot, are classified into an intelligent device subgroup 2. Intelligent devices with a cooking function, such as an intelligent rice cooker and an intelligent microwave oven, are classified into an intelligent device subgroup 3.

Subgroup group information may be obtained among intelligent device subgroups through conversion of device data. The sweeping robot is used as an example. Each sweeping robot senses its location and information such as a distance and orientation between itself and another sweeping robot by its own sensor. In addition, each sweeping robot releases its own intelligent device data to each other, including data such as a location, a distance, an orientation, a function, and performance, to implement information synchronization, so as to construct subgroup group information. Eventually, each sweeping robot has all information of all sweeping robots in a sweeping robot cluster.

As shown in FIG. 5, for example, when a user delivers a sweeping command, after any sweeping robot in the intelligent device subgroup 2 receives the command of the user, the sweeping robots collaboratively make a decision, based on information of an entire room that includes a quantity of floors, a quantity of rooms, a size of each room, and the like, and data such as a total quantity of sweeping robots, performance of each sweeping robot, to implement optimal and quick cleaning. At the same time, the command of the user is sent to another intelligent device in the same intelligent device subgroup. Each intelligent device in the intelligent device subgroup 2 performs calculation according to the received command of the user and based on synchronized device data of each intelligent device by using a same collaboration algorithm, to obtain a respective subtask. Subtasks of each intelligent device collaborate with each other to complete the sweeping command delivered by the user. In another embodiment, after receiving a task command delivered by the user, any intelligent device selects a suitable intelligent device subgroup based on a task feature in the command information, and sends the task to any intelligent device in the suitable intelligent device subgroup. For example, a smart television in the intelligent device subgroup 1 receives the command of the user, and sends the command of the user to any intelligent device in the intelligent device subgroup 2.

In a specific example, for example, currently, there are three rooms in total, a room 1 is 20 square meters, a room 2 is 30 square meters, a room 3 is 40 square meters, a total quantity of the sweeping robots is 3, a sweeping robot A can sweep 2 square meters per minute, a sweeping robot B can sweep 3 square meters per minute, and a sweeping robot C can sweep 4 square meters per minute. The sweeping robot A is in the room 1, the sweeping robot B is in the room 3, and the sweeping robot C is in the room 2. It takes the sweeping robot A 4 minutes and 6 minutes respectively to go to the room 2 and the room 3 from the room 1, it takes the sweeping robot C 2 minutes to go to the room 3 from the room 2, and it takes the sweeping robot B 3 minutes to go to the room 2 from the room 3.

Each sweeping robot may calculate, based on the foregoing information, that the sweeping robot A needs 10 minutes to clean the room 1, the sweeping robot B needs 10 minutes to clean the room 2, and the sweeping robot C needs 10 minutes to clean the room 3. However, the sweeping robot B needs 3 minutes to go to the room 2 from the room 3, and the sweeping robot C needs 2 minutes to go to the room 3 from the room 2. Therefore, it takes a minimum of 13 minutes to clean up. Each intelligent device starts cleaning based on a calculation result. When a sweeping robot finishes cleaning or fails to clean due to insufficient battery power, related information will be synchronized to other sweeping robots. Then other sweeping robots dynamically adjust a cleaning task based on the synchronized information. Finally, the plurality of sweeping robots collaboratively complete the cleaning task, to complete a task in an optimal manner.

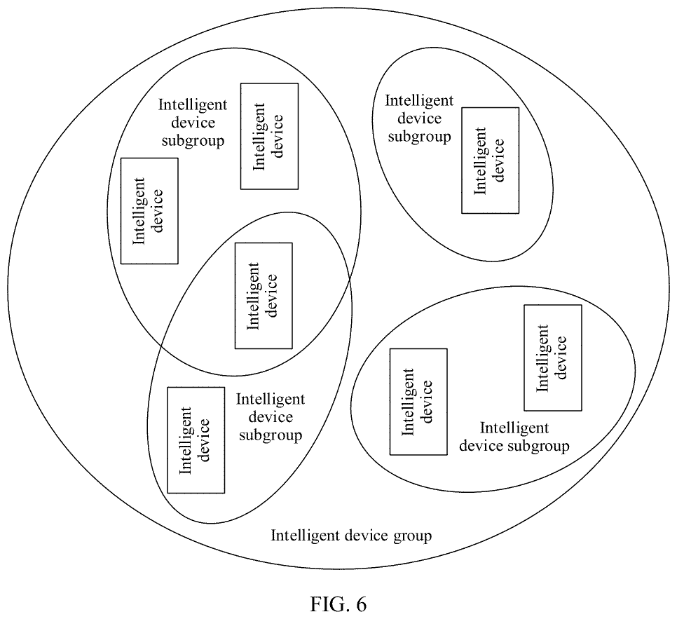

FIG. 6 is a schematic diagram of an intelligent device group according to an embodiment of the present disclosure.

As shown in FIG. 6, an intelligent device group is provided, including a plurality of intelligent devices. The plurality of intelligent devices include a first intelligent device and at least one second intelligent device. The first intelligent device receives a task instruction, according to the task instruction and based on device data of the first intelligent device, and device data of at least one second intelligent device in an intelligent device subgroup in which the first intelligent device is located, a subtask corresponding to the first intelligent device is determined by using a collaboration algorithm, where The collaboration algorithm is consistent with a collaboration algorithm that is in the second intelligent device and that is used to determine a subtask corresponding to the second intelligent device, and the subtask corresponding to the first intelligent device is used to collaborate with the subtask corresponding to the second intelligent device to complete a task corresponding to the task instruction, and the subtask corresponding to the first intelligent device is executed.

In an embodiment, the intelligent device group further includes the first intelligent device, configured to send the task instruction to the at least one second intelligent device in the intelligent device subgroup in which the first intelligent device is located.

In an embodiment, that the first intelligent device receives the task instruction includes receiving, by the first intelligent device, a task instruction sent by a third intelligent device, where the third intelligent device is any intelligent device, in the intelligent device group, other than the first intelligent device and the at least one second intelligent device. The intelligent device group includes the intelligent device subgroup in which the first intelligent device is located.

In an embodiment, the intelligent device group is established by the plurality of intelligent devices by using a network, and the plurality of intelligent devices include the first intelligent device, the at least one second intelligent device, and the third intelligent device.

In an embodiment, the intelligent device group includes at least one intelligent device subgroup. Device data of the plurality of intelligent devices includes device function information, the at least one intelligent device subgroup is obtained after classification of the plurality of intelligent devices based on the device function information, and the at least one intelligent device subgroup includes the intelligent device subgroup in which the first intelligent device is located.

In an embodiment, manners in which the first intelligent device obtains the device data of the at least one second intelligent device include multicast, broadcast, or gossip.

According to the present disclosure, in an area such as a household, an intelligent device group is established by intelligent devices that actively sense and discover each other. The intelligent devices in the group collaborate with each other, and automatically and collaboratively form a “homogeneous” intelligent device subgroup based on a feature of the intelligent device. Subgroup group information is constructed based on multi-intelligent device multi-sensor knowledge fusion technology, to ensure that each intelligent device in the group has same device information when executing a task. In addition, a plurality of intelligent device subgroups may collaborate with each other. Based on a user task, an intelligent device subgroup that provides a service is automatically selected. The intelligent devices collaboratively make a decision based on same input and a similar algorithm. The intelligent devices in the group collaboratively complete a task. This resolves a problem that a single intelligent device is not fully capable of completing a complex task. A central node of the group of devices is removed. This reduces information interaction between the intelligent device and a central device, and dynamically adjusts a task processing solution in real time based on calculation, to provide optimal experience for the user.

A person skilled in the art may be further aware that, in combination with the examples described in the embodiments disclosed in this specification, units and algorithm steps may be implemented by electronic hardware, computer software, or a combination of the two. To clearly describe interchangeability between the hardware and the software, compositions and steps of each example have generally been described in the foregoing specification based on functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

A person of ordinary skill in the art may understand that all or a part of the steps in each of the foregoing method of the embodiments may be implemented by a program instructing a processor. The foregoing program may be stored in a computer-readable storage medium. The storage medium may be a non-transitory medium, for example may be a random-access memory, read-only memory, a flash memory, a hard disk, a solid state drive, a magnetic tape, a floppy disk, an optical disc, or any combination thereof.

The foregoing descriptions are merely example implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A collaboration method, comprising:
establishing, by a plurality of intelligent devices, an intelligent device subgroup by sharing respective device data with each other based on feature data of each intelligent device and sensor information;
receiving, by a first intelligent device in the intelligent device subgroup, a first task instruction;
obtaining, by the first intelligent device and using a first collaboration algorithm, a first subtask that corresponds to the first intelligent device and that is based on the first task instruction, first device data of the first intelligent device, and second device data of a second intelligent device in the intelligent device subgroup, wherein the first collaboration algorithm is consistent with a second collaboration algorithm of the second intelligent device, wherein the first collaboration algorithm determines a second subtask corresponding to the second intelligent device, and wherein the first subtask collaborates with the second subtask to complete a task corresponding to the first task instruction; and
executing, by the first intelligent device, the first subtask.

2. The collaboration method of claim 1, further comprising sending, by the first intelligent device, the first task instruction to the second intelligent device.

3. The collaboration method of claim 1, further comprising further receiving, by the first intelligent device, the first task instruction from a third intelligent device in an intelligent device group, wherein the intelligent device group comprises the intelligent device subgroup.

4. The collaboration method of claim 3, wherein the intelligent device group comprises the intelligent devices, and wherein the intelligent devices comprise the first intelligent device, the second intelligent device, and the third intelligent device.

5. The collaboration method of claim 3, further comprising obtaining, by the first intelligent device, the second device data in a multicast manner.

6. The collaboration method of claim 3, further comprising obtaining, by the first intelligent device, the second device data in a broadcast manner.

7. The collaboration method of claim 3, further comprising obtaining, by the first intelligent device, the second device data in a gossip manner.

8. The collaboration method of claim 1, wherein the first device data and the second device data have the same device function information.

9. The collaboration method of claim 8, wherein the device function information comprises information about a playing function, a cooking function, a cleaning function, or an image shooting function.

10. The collaboration method of claim 1, wherein the first task instruction comprises a task type.

11. A first intelligent device in an intelligent device subgroup, wherein the first intelligent device is configured to:
receive a first task instruction, wherein the intelligent device subgroup is established by a plurality of intelligent devices by sharing respective device data with each other based on feature data of each intelligent device and sensor information;
obtain, using a first collaboration algorithm, a first subtask that corresponds to the first intelligent device and that is based on the first task instruction, first device data of the first intelligent device, and second device data of a second intelligent device in the intelligent device subgroup, wherein the first collaboration algorithm is consistent with a second collaboration algorithm of the second intelligent device, wherein the first collaboration algorithm determines a second subtask corresponding to the second intelligent device, and wherein the first subtask collaborates with the second subtask to complete a task corresponding to the first task instruction;
execute the first subtask; and
record a historical optimal value of each intelligent device and a group optimal value of the intelligent device subgroup to perform an iterative update on the feature data of each intelligent device.

12. The first intelligent device of claim 11, further configured to send the first task instruction to the second intelligent device.

13. The first intelligent device of claim 11, further configured to receive the first task instruction from a third intelligent device in the intelligent device group, wherein the intelligent device group comprises the intelligent device subgroup.

14. The first intelligent device of claim 11, wherein the intelligent device group comprises the intelligent devices, and wherein the intelligent devices further comprise the first intelligent device, the second intelligent device, and the third intelligent device.

15. The first intelligent device of claim 11, further configured to obtain the second device data in a multicast manner, a broadcast manner, or a gossip manner.

16. A non-transitory computer-readable medium storing machine-readable instructions which, when executed by a processor, cause a first intelligent device in an intelligent device subgroup to:
receive a first task instruction, wherein the intelligent device subgroup is established by a plurality of intelligent devices by sharing respective device data with each other based on feature data of each intelligent device and sensor information;
obtain, using a first collaboration algorithm, a first subtask that corresponds to the first intelligent device and that is based on the first task instruction, first device data of the first intelligent device, and second device data of a second intelligent device in the intelligent device subgroup, wherein the first collaboration algorithm is consistent with a second collaboration algorithm of the second intelligent device, wherein the first collaboration algorithm determines a second subtask corresponding to the second intelligent device, and wherein the first subtask collaborates with the second subtask to complete a task corresponding to the first task instruction; execute the first subtask; and
record a historical optimal value of each intelligent device and a group optimal value of the intelligent device subgroup for performing an iterative update on the feature data of each intelligent device.

17. The non-transitory computer-readable medium of claim 16, wherein the instructions, when executed by the processor, further cause the first intelligent device to send the first task instruction to the second intelligent device.

18. The non-transitory computer-readable medium of claim 16, wherein the instructions, when executed by the processor further cause the first intelligent device to further receive the first task instruction from a third intelligent device in an intelligent device group, and wherein the intelligent device group comprises the intelligent device subgroup.

19. The non-transitory computer-readable medium of claim 16, wherein the intelligent device group comprises intelligent devices, and wherein the intelligent devices comprise the first intelligent device, the second intelligent device, and the third intelligent device.

20. The non-transitory computer-readable medium of claim 16, wherein the instructions, when executed by the processor, further cause the first intelligent device to obtain the second device data in a multicast manner, a broadcast manner, or a gossip manner.
